(19) United States
(12) Patent Application Publication
(10) Pub. No.: US 2008/0252436 A1
(43) Pub. Date: Oct. 16, 2008

(54) Self-diagnostic angular speed sensor for vehicle

(75) Inventor: Norifumi Souda, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/896,814

(22) Filed: Sep. 6, 2007

(30) Foreign Application Priority Data
Sep. 14, 2006 (JP) JP 2006-249056

(51) Int. Cl. B60Q 1/00

(52) U.S. Cl. 340/441

(57) ABSTRACT

An angular speed sensor for a vehicle includes an angular speed sensor unit mounted in the vehicle, a microcomputer in which an offset correction value storing section and a diagnosis section are incorporated. The offset correction value storing section stores an offset correction value, which is an angular speed that is most frequently detected by the angular speed sensor. The diagnosis section corrects a current angular speed by the offset correction value.

### CROSS REFERENCE TO RELATED APPLICATION

The present application is based on and claims priority from Japanese Patent Application 2006-249056, filed Sep. 14, 2006, the contents of which are incorporated herein by reference.

### BACKGROUND OF THE INVENTION

1. Field of the Invention

The present invention relates to an angular speed sensor to be equipped with a vehicle, in which an angular speed signal is monitored and corrected.

2. Description of the Related Art

JP-5-157572 A discloses a navigation system that is equipped with an angular speed sensor. Such a navigation system has a function to correct an offset value in the output signal of the angular speed sensor. The navigation system includes a system controller, a geomagnetic sensor for detecting a driving direction of a vehicle, an angular speed sensor for detecting an angular speed of the vehicle, an travel distance sensor, such as a wheel speed sensor, etc.

In such a navigation system, the system controller monitors the output signals of the travel distance sensor, the angular speed sensor and the geomagnetic sensor. When the vehicle stops, the system controller calculates a rate of change in the angular speed and a rate of change in the direction of the vehicle based on the output signal of the travel distance sensor. If both the rate of change in the angular speed and the rate of change in the driving direction of the vehicle respectively fall within predetermined values, a standard value, which is an offset value, is replaced for the output signal of the angular speed sensor. In other words, the offset value of the angular speed is canceled by the system controller when the output signal of the angular speed sensor is 0 deg/sec.

However, it is necessary for the system controller to have the travel distance sensor to detect whether the vehicle stops or not. If the travel distance sensor goes out of order, the system controller can not correct the angular speed, resulting in that the navigation system may not work well.

### SUMMARY OF THE INVENTION

Therefore, an object of the invention is to solve the above problem by providing an angular speed sensor that can diagnose and correct the output signal of the angular speed sensor without using such a travel distance sensor.

According to a feature of the invention, an angular speed sensor mounted in a vehicle includes a sensor unit that detects an angular speed of the vehicle, an offset correction value storing means that stores data of the detected angular speed in a histogram to find out a most frequently detected angular speed as a offset correction value and a diagnosis means that corrects a current angular speed by the offset correction value.

Therefore, it is not necessary to have an additional device for detecting whether the vehicle is standing or running, such as a travel distance sensor.

The above angular speed sensor further includes a microcomputer that incorporates the offset correction value storing means, the diagnosis means and an A/D converter connected to the sensor unit. The angular speed detected at a maximum frequency in the above embodiment is preferably 0 deg/sec.

The above angular speed sensor may further include a memory connected to the offset correction value storing means for storing the angular speed detected at a maximum frequency as an offset correction value, means for examining whether the offset correction value is normal or not, means for outputting the corrected angular speed when it is judged that the offset correction value is normal and means for renewing the offset correction value stored in the memory if it is judged not normal.

In this angular speed sensor, the diagnosis means renews the data of angular speeds that have been stored when the offset correction value stored in the memory is renewed.

According to another feature of the invention, an angular speed sensor mounted in a vehicle includes detecting means for detecting angular speed of the vehicle, a memory for storing a first offset correction value, correcting means for correcting the angular speed by the first offset correction value, histogram data storing means for storing data of the angular speed corrected by the correcting means in a histogram, mode value setting means for setting the angular speed at a maximum frequency in the histogram to a mode value, judging means for judging that the angular speed detected by the detecting means is normal when the mode value is equal to a reference value, renewing means for providing a second offset correction value that is equal to the reference value to replace the second offset correction value for the first offset correction value stored in the memory when the judging means judges that the angular speed detected by the detecting means is not normal, and output means for outputting an angular speed corrected by the first offset collection value when the judging means judges that the angular speed detected by the detecting means is normal and outputting an angular speed corrected by the second offset correction value when the judging means judges that the angular speed detected by the detecting means is not normal.

In this embodiment, the renewing means renews the histogram stored in the histogram storing means if the judging means judges that the angular speed detected by the detecting means is not normal.

According to another feature of the invention, an angular speed sensor mounted in a vehicle includes a sensor unit that detects an angular speed of the vehicle, an offset correction value storing means that stores angular speeds that are detected time to time in a current distribution pattern of measure of the angular speed with respect to frequency of detection of the angular speed, a memory for storing angular speeds that are detected time to time and judged to be normal in a normal distribution pattern of measure of the angular speed with respect to frequency of detection of the same angular speed, and a diagnosis means for correcting a current angular speed by an offset correction value, wherein the diagnosis means shifts the center of gravity or mode value (hereinafter referred to as mode value) of the current distribution pattern to the mode value of the normal distribution pattern.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a block diagram illustrating the components of an angular speed sensor for a vehicle according to the first embodiment of the invention;

FIG. 2 is a flow diagram of diagnosis and correction in the angular speed sensor according to the first embodiment;

FIG. 3 is a histogram displaying a relation between an offset value of a sensor signal and a frequency of detection of the sensor signals having the same measure or magnitude;

FIG. 4 is a histogram displaying a relation between an offset value of the sensor signal and a maximum frequency of detection of the sensor signals having the same measure or magnitude;

FIG. 5 is a block diagram illustrating the components of an angular speed sensor for a vehicle according to the second embodiment of the invention;

FIG. 6 is a flow diagram of diagnosis and correction in the angular sensor according to the second embodiment;

FIG. 7 is a histogram showing a relation between an angular speed and a frequency of detection of the same angular speed;

FIG. 8 is a histogram showing a relation between an angular speed and a frequency of detection of the same angular speed;

FIG. 9 is a time diagram illustrating change in the sensor signal and correction of an offset value; and

FIG. 10 is a block diagram illustrating components of an angular speed sensor for a vehicle according to the third embodiment of the invention.

### DETAILED DESCRIPTION OF THE PREFERRED EMBODIMENTS

Some preferred embodiments according to the present invention will be described with reference to the appended drawings.

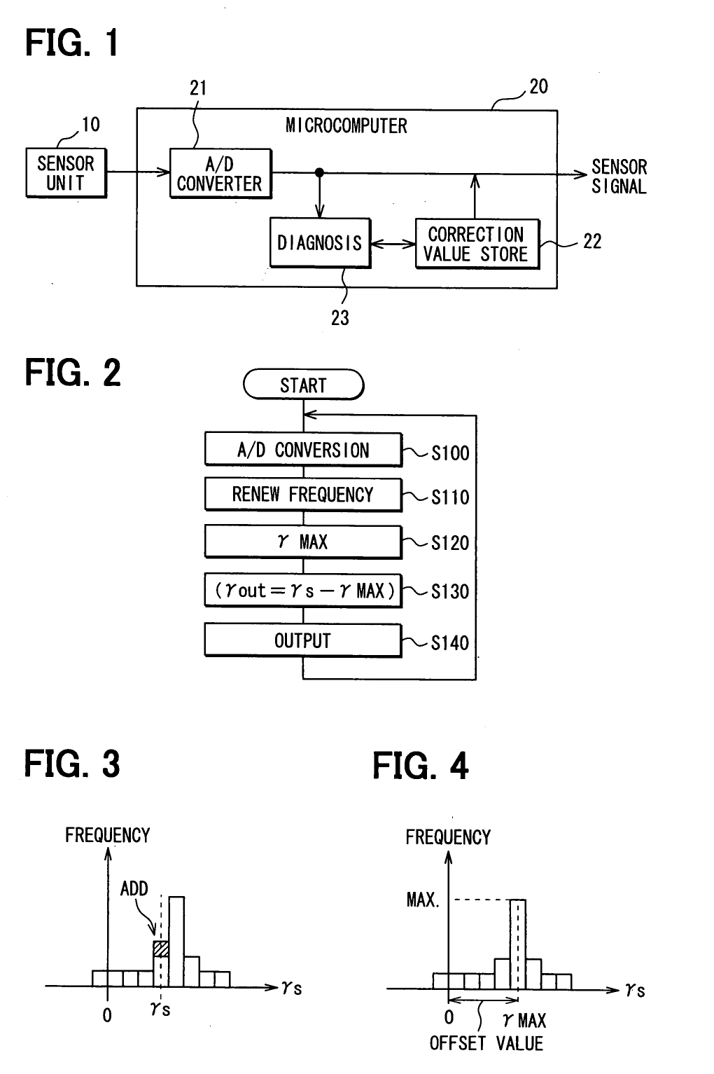

An angular speed sensor according to the first embodiment of the invention will be described with reference to FIGS. 1-4.

The angular speed sensor according to the first embodiment of the invention may be used for maintaining driving stability of a vehicle. As shown in FIG. 1, the angular speed sensor includes a sensor unit 10 and a microcomputer 20.

The sensor unit 10 is a vibratory gyroscope that includes a weight and a piezoelectric transducer. When the weight that swings in a first direction (i.e. primary vibration) is placed on a vehicle that rotates at an angular speed, a Coriolis force is applied to the weight, resulting in that the weight also swings in a second direction that is perpendicular to the first direction (i.e. secondary vibration). The amplitude of the secondary vibration is detected by the piezoelectric transducer of the sensor unit 10 as an analog signal. The microcomputer 20 includes an A/D converter 21, a correction value storing section 22, a diagnosis section 23, a CPU, a ROM, etc.

The A/D converter 21 converts the analog output signal of the sensor unit 10 into a digital sensor signal. The correction value storing section 22 is constructed of a RAM and takes in the digital sensor signal from the A/D converter 21 via the diagnosis circuit 23 and memorizes the frequency of detection of the digital sensor signals. In other words, the correction value storing section 22 provides a histogram displaying the frequencies of detection of digital sensor signals having the same range of measure or magnitude that corresponds to the angular speed. The histogram is formed when the ignition key switch is positioned at “ON” position or “ACC” position. The number of the signals that forms the histogram may be ten or more.

The diagnosis section 23 picks up a most frequently detected sensor signal from the sensor signals that are stored in the correction value storing section 22. The diagnosis section 23 provides an offset correction value based on the most frequently detected sensor signal and corrects the currently detected sensor signal by the offset correction value. The diagnosis section carries out the above functions according to a program that is stored in a ROM.

The sensor unit 10 is expected to provide a sensor signal of 0 deg/sec when no angular speed exists. If the sensor unit 10 provides a sensor signal of, for example, 2 deg/sec due to some reason such as a variation of a manufacturing process, the sensor signal of 2 deg./sec is an offset value.

In this case, an offset correction program is started when the ignition switch is turned on. As shown in FIG. 2, an A/D conversion step is carried out at step S100 when the offset correction program is started. In this step, an analog signal sent from the sensor unit 10 is converted into a digital sensor signal γs.

At S110, the frequency of detection of each level of the sensor signals is added to data that form a histogram. In this step, the digital sensor signal γs is inputted to the correction value storing section 22, as shown in FIG. 3.

At S120, a maximum frequency sensor signal γMAX that is the sensor signal γs detected at a maximum frequency is picked up, as shown in FIG. 4. This sensor signal of maximum frequency γMAX is used as an offset correction value.

When a vehicle is standing still with the ignition switch being turned on, no angular speed is detected. In other words, the angular speed is 0 deg/sec. When the vehicle is running on a highway for a long time, the angular speed of 0 deg/sec is detected at maximum frequency because such a highway is usually straight. Incidentally, a small angular speed may be detected whether the vehicle is running or not due to electric noises or mechanical vibrations whenever the ignition switch is turned on. However, this angular speed usually disperses one or the other direction from 0 deg/sec. Because the vehicle will not turn at a small angular speed that is less than the resolution of the A/D converter for a certain period, the angular speed that is detected while the vehicle is turning is not as accurate as the angular speed 0 deg/sec while the vehicle is standing.

At S130, the currently detected digital sensor signal γs is corrected by the offset correction value (maximum frequency sensor signal) γMAX to have a corrected sensor signal γout. The offset correction value γMAX (negative value) is taken by the diagnosis section 23 out of the correction value storing section 22 and added to the digital sensor signal sent from the A/D converter 21. Thus, the sensor signal is corrected. That is: γout=γs−γMAX. If there is no offset in the digital sensor signal, the currently detected digital sensor signal γs of 0 deg/sec is corrected by the maximum frequency sensor signal γMAX of 0 deg/sec. That is: γout=0

At S140, the corrected signal γout is outputted. Thereafter, the step returns to S100 to repeat the above steps S100-S140. In the meanwhile, the histogram of data provided by the correction value storing section 22 is renewed repeatedly until it is erased when the key switch is turned off.

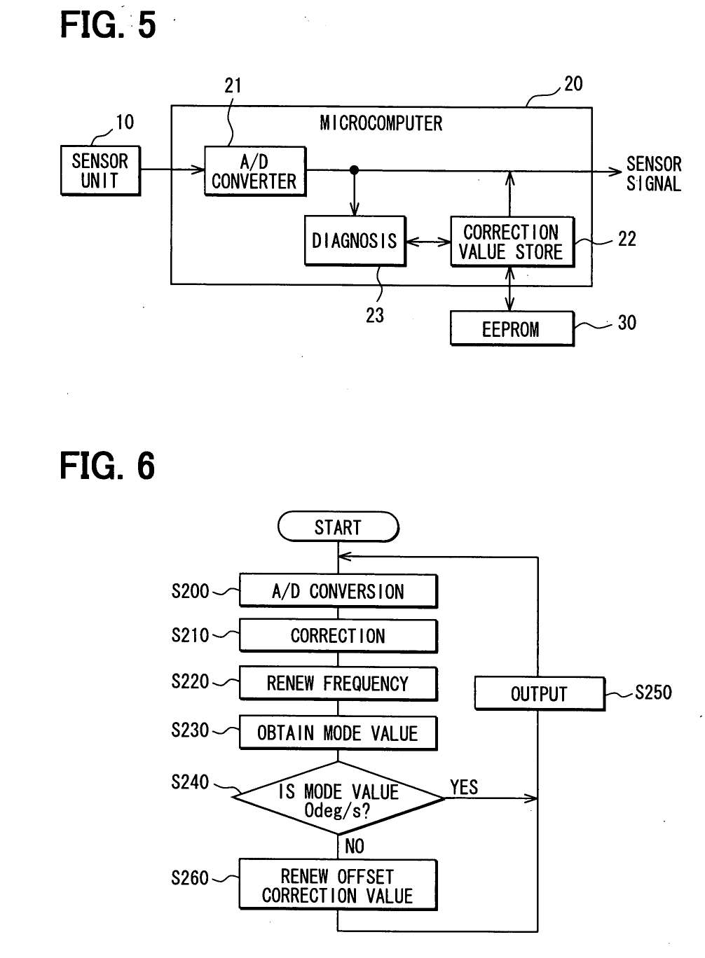

An angular speed sensor according to the second embodiment of the invention will be described with reference to FIGS. 5-9. Incidentally, the same reference numeral as the description about the first embodiment is the same or substantially the same part, portion or component as the first embodiment, hereafter.

As shown in FIG. 5, the angular speed sensor includes a sensor unit 10, a microcomputer 20 and an EEPROM 30.

The EEPROM 30 stores data of the offset correcting values of a normal distribution, which are inputted to the correction value storing section 22 when the operation of the angular speed sensor 10 is started. Incidentally, the normal distribution is a distribution of frequencies of detection of the sensor signals having the same measure or magnitude that corresponds to each level of the angular speed. The offset correction value is the angular speed that is positioned at the mode value of the normal distribution pattern. The offset correction value is stored in the EEPROM 30 when the angular speed sensor is shipped. That is, the offset correction value is to adjust the angular speed sensor to output 0 deg/sec when a vehicle is standing still.

The correction value storing section 22 is formed in the microcomputer 20 to take in an offset correction value to add the same to the digital sensor signal that is outputted by the A/D converter 21. The correction value storing section 22 provides a histogram of the frequency of detection of digital sensor signals having the same measure or magnitude that corresponds to each level of the angular speed.

If the most frequently detected sensor signal of the histogram does not correspond to the angular speed of 0 deg/sec, the diagnosis section 23 takes in an offset correction value to cancel the angular speed other than 0 deg/sec from the correction value storing section 22 and stores the offset correction value into the EEPROM 30, thereby renewing the correction value.

As shown in FIG. 6, the diagnosis section 23 carries out the above functions according to an offset correction program that is stored in the ROM.

The offset correction program is started when the ignition switch is turned on, and an A/D conversion step is carried out at step S200 when the offset correction program is started.

At S210, the offset correction value is outputted from the offset correction value storing section 22 to be added to the currently detected digital sensor signal that is outputted from the A/D converter 21, thereby correcting the sensor signal.

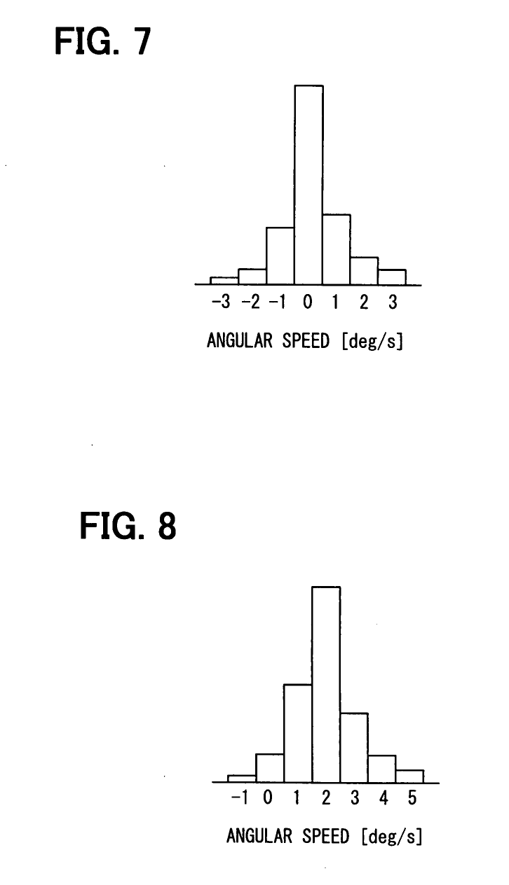

At S220, the corrected sensor signal is inputted to the offset correction value storing section 22 via the diagnosis section 23 to be added to the histogram in a normal distribution pattern, as shown in FIG. 7, in which the frequency of detection of the angular speed being 0 deg/sec is the maximum and positioned at the mode value of the normal distribution pattern. Incidentally, the sensor signal of the maximum frequency is referred to as a mode value.

The mode value is obtained at S230 to examine whether the mode value is equal to 0 deg/sec or not at S240. When the mode value (e.g. 0 deg/sec) is obtained, whether the frequency of detection of the angular speed is conspicuously higher than others (as shown in FIG. 7) is examined.

If the examination result is YES, it is confirmed that the offset correction carried out at S210 is correct and the corrected angular speed is outputted at S250. Thereafter, the above steps from S200 to S250 are repeated. If the examination result of S240 is No as in the case that the mode value is 2 deg/sec in a current distribution pattern as shown in FIG. 8, the offset correction value is renewed at S260. Thereafter, the above steps are repeated.

Here, the examination at S240 is to compare the normal distribution pattern that is stored in the memory 30 and the current distribution pattern that is stored in the offset correction value storing section 23, and the correction at S260 is to shift the mode value of the current distribution pattern to the mode value of the normal distribution pattern.

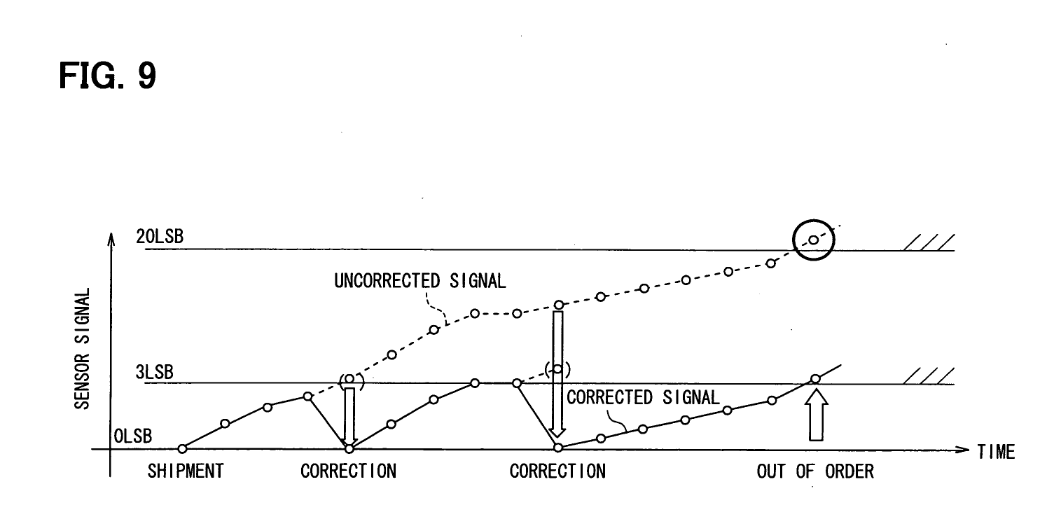

If the mode value changes with the passage of time, the offset correction may be carried out as shown in FIG. 9.

When the angular speed sensor is shipped, the mode value is 0 deg/sec. The mode value changes as time passes. However, the mode value being 0 deg/sec can be judged in the examination at S240 as far as the change is within 3 LSB if the digital sensor signal changes by 0.244 deg/sec each LSB (least significant bit) when 10-bit-data is A/D-converted. Otherwise, the sensor signal is corrected. In this case, the offset correction value is renewed at S260. If the digital sensor signal is larger than 20 LSB, it is judged that the sensor unit 10 goes out of order and a failure flag is set at S250.

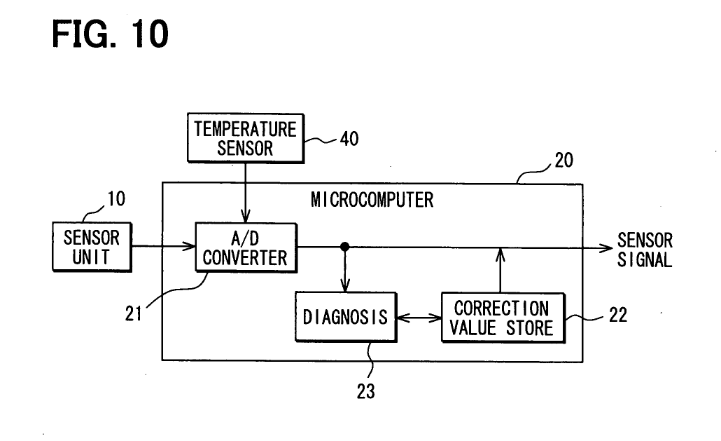

An angular speed sensor according to the third embodiment of the invention will be described with reference to FIG. 10.

The angular speed sensor includes a sensor unit 10, a microcomputer 20 and a temperature sensor 40. The temperature sensor 40 is connected to the A/D converter 21 of the microcomputer 20.

Only when the temperature detected by the temperature sensor 40 falls in an ordinary temperature range, such as temperature between −20° C. and 40° C., the diagnosis section 23 operates according to the flow diagram as shown in FIG. 2. Thus, an offset correction provided at an abnormal temperature, which may cause further offset from the offset value at an ordinary temperature range, can be avoided.

In the above embodiments of the invention, the histogram may be renewed each preset time such as 1 minute or 10 minutes. In renewing the histogram, the mode value may be obtained by assigning a weight to the peak value such as: (renewed maximum value)=(last maximum value/2)+(current maximum value). The divisor “2” may be changed according to circumstances.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. An angular speed sensor for a vehicle comprising:
a sensor unit, mounted in the vehicle, for detecting an angular speed of the vehicle;
an offset correction value storing means for storing data of the detected angular speed in a histogram to find out a most frequently detected angular speed as a offset correction value; and
a diagnosis means for correcting a current angular speed by the offset correction value.

2. An angular speed sensor as in claim 1, further comprising a microcomputer that incorporates the offset correction value storing means, the diagnosis means and an A/D converter connected to the sensor unit.

3. An angular speed sensor as in claim 1, wherein the angular speed detected at a maximum frequency is 0 deg/sec.

4. Angular speed sensor as in claim 1 further comprising:
a memory connected to the offset correction value storing means for storing the angular speed detected at a maximum frequency as an offset correction value;
means for examining whether the offset correction value is normal or not;
means for outputting the corrected angular speed when it is judged that the offset correction value is normal; and
means for renewing the offset correction value stored in the memory if it is judged not normal.

5. An angular speed sensor as in claim 4, wherein the diagnosis means renews the data of angular speeds that have been stored when the offset correction value stored in the memory is renewed.

6. An angular speed sensor for a vehicle comprising:
detecting means for detecting angular speed of the vehicle
a memory for storing a first offset correction value;
correcting means for correcting the angular speed by the first offset correction value stored in the memory;
histogram data storing means for storing data of the angular speed corrected by the correcting means in a histogram;
mode value setting means for setting the angular speed at a maximum frequency in the histogram to a mode value;
judging means for judging that the angular speed detected by the detecting means is normal when the mode value is equal to a reference value;
renewing means for providing a second offset correction value that is equal to the reference value to replace the second offset correction value for the first offset correction value stored in the memory when the judging means judges that the angular speed detected by the detecting means is not normal; and
output means for outputting an angular speed corrected by the first offset collection value when the judging means judges that the angular speed detected by the detecting means is normal and outputting an angular speed corrected by the second offset correction value when the judging means judges that the angular speed detected by the detecting means is not normal.

7. An angular speed sensor as in claim 6, wherein the renewing means renews the histogram stored in the histogram storing means if the judging means judges that the angular speed detected by the detecting means is not normal.

8. An angular speed sensor for a vehicle comprising:
a sensor unit, mounted in the vehicle, for detecting an angular speed of the vehicle;
an offset correction value storing means for storing angular speeds that are detected time to time in a current distribution pattern having a first mode value with respect to frequency of detection of the same angular speed;
a memory for storing angular speeds that are detected time to time and judged to be normal in a normal distribution pattern having a second mode value with respect to frequency of detection of the same angular speed;
and
a diagnosis means for correcting a current angular speed by an offset correction value,
wherein the diagnosis means shifts the first mode value to the second mode value, thereby correcting the offset correction value.

9. An angular speed sensor as in claim 8, wherein the sensor unit detects an angular speed when the vehicle stand still.

10. An angular speed sensor as in claim 9 further comprising a key switch having an engine start switch ON and an accessory switch ACC, wherein the sensor unit detects an angular speed when the key switch is positioned at one of ON and ACC.

11. An angular speed sensor as in claim 1 further comprising a temperature sensor, wherein the temperature sensor prohibit the sensor unit to detect an angular speed when room temperature is out of a preset range.

12. An angular speed sensor for a vehicle comprising:
detecting means for repeatedly detecting angular speed of the vehicle when the vehicle stand still;
a memory for storing a first offset correction value;
correcting means for correcting the angular speed by the first offset correction value;
mode value storing means for storing an angular speed of same measure that is most frequently detected as a mode value;
judging means for judging that the angular speed detected by the detecting means is normal when the mode value is equal to a reference value;
renewing means for providing a second offset correction value that is equal to the reference value to replace the second offset correction value for the first offset correction value when the judging means judges that a currently detected angular speed is not normal; and
output means for outputting an angular speed corrected by the first offset collection value when the judging means judges that the angular speed detected by the detecting means is normal and outputting an angular speed corrected by the second offset correction value when the judging means judges that the angular speed detected by the detecting means is not normal.
